(19) United States
(12) Patent Application Publication
(10) Pub. No.: US 2019/0058637 A1
(43) Pub. Date: Feb. 21, 2019

(54) MAPPING OF NETWORK DEVICE CONNECTIVITY USING PERFORMANCE DATA

(71) Applicant: Level 3 Communications, LLC, Broomfield, CO (US)

(72) Inventor: Steve R. Wakumoto, Golden, CO (US)

(21) Appl. No.: 16/102,226

(22) Filed: Aug. 13, 2018

Related U.S. Application Data
(60) Provisional application No. 62/545,825, filed on Aug. 15, 2017.

(51) Int. Cl. H04L 12/24; H04L 12/26

(52) U.S. Cl. CPC H04L 41/12; H04L 43/04; H04L 43/0805; H04L 43/062; H04L 41/085

(57) ABSTRACT

Systems and methods for mapping connections within a computer network include collecting performance data, such as quantities of data sent and received, for interfaces of network devices included in the computer network. One or more statistical analyses are then applied to the performance data to determine likely pairings of interfaces. For example, ratios of the quantity of data sent by a first interface to data received by a second interface and the quantity of data received by the first interface to data sent by the second interface may be evaluated to see if each ratio falls within a margin of error. If so, the corresponding interfaces are considered connected and an entry in a connection database describing the network topology may be created.

### CROSS-REFERENCE TO RELATED APPLICATION

This application is related to and claims priority under 35 U.S.C. § 119(e) from U.S. Patent Application No. 62/545,825, filed Aug. 15, 2017, titled “MAPPING OF NETWORK DEVICE CONNECTIVITY USING PERFORMANCE DATA”, the entire contents of which is incorporated herein by reference for all purposes.

### TECHNICAL FIELD

Aspects of the present disclosure involve mapping of networks. More specifically, aspects of the present disclosure involve a method for using performance metrics to determine interconnections between interfaces of devices within networks.

### BACKGROUND

Effective management of a telecommunications network is benefited from maintaining an accurate list of the devices contained within the network and interconnections between interfaces of network devices. Such information is important for, among other things, provisioning new network services over the network, coordinating and performing network maintenance, analyzing network performance, and, more generally, making the most effective use of network resources. Given the size and complexity of modern networks, however, collecting and maintaining such data can be a time and resource intensive task.

It is with these observations in mind, among others, that aspects of the present disclosure were conceived.

### SUMMARY

In one implementation of the present disclosure, a method of mapping connections in a network is provided. The method includes obtaining traffic data including quantities of data sent and received for interfaces within the computer network at a computing device communicatively coupled to the network. The method further includes identifying, using the computing device, a potential connection between a pair of the interfaces by determining that quantities of data sent and received for a first interface of the pair of interfaces for a time period correspond to quantities of data received and sent, respectively, for a second interface of the pair of interfaces for the time period. The method also includes generating and storing network topology data including a record corresponding to the potential connection, the record including an identifier for each of the first interface and the second interface.

In another aspect of the present disclosure, a system for mapping connections of a network including a plurality of interfaces is provided. The system includes a computing device communicatively coupled to the network. The computing device is configured to obtain traffic data for the network, the traffic data corresponding to quantities of data sent and received from each of the plurality of interfaces. The computing device is further configured to predict, based on a statistical analysis of the traffic data, connections between one or more pairs of the plurality of interfaces. Identifying each connection includes determining that quantities of data sent and received for a first interface of the pair of interfaces for a time period correspond to quantities of data received and sent, respectively, for a second interface of the pair of interfaces for the time period. The computing device is further configured to automatically update a database of network topology data by adding or modifying a record of the database for each potential connection generate and store network topology data including a record corresponding to each predicted connection, each record including an identifier for each of the first interface and the second interface of the predicted connection.

In yet another aspect of the present disclosure, a method of identifying connections between devices of a network is provided. The method includes obtaining, at a computing device, each of first performance data for a first interface of the network and second performance data for a second interface of the network. The first performance data includes each of a quantity of data sent through the first interface during a time period and a quantity of data received through the first interface during the time period. Similarly, the second performance data includes each of a quantity of data sent through the second interface during the time period and a quantity of data received through the second interface during the time period. The method further includes identifying a connection between the first interface and the second interface by determining each of a first ratio and a second ratio are within a margin of error, the first ratio being the quantity of data sent through the first interface to the quantity of data received by the second interface and the second ratio being the quantity of data sent from the second interface to the quantity of data received by the first interface. The method further includes, in response to identifying the connection, automatically updating a database record corresponding to the connection using the computing device.

### BRIEF DESCRIPTION OF THE DRAWINGS

The foregoing and other objects, features, and advantages of the present disclosure set forth herein will be apparent from the following description of particular embodiments of those inventive concepts, as illustrated in the accompanying drawings. It should be noted that the drawings are not necessarily to scale; however the emphasis instead is being placed on illustrating the principles of the inventive concepts. Also, in the drawings the like reference characters may refer to the same parts or similar throughout the different views. It is intended that the embodiments and figures disclosed herein are to be considered illustrative rather than limiting.

FIG. 1 is a schematic illustration of an example network environment including a computing device for mapping connections within a primary network of the network environment.

FIG. 2 is a flow chart illustrating a method of mapping connections within a network, such as the primary network of FIG. 1.

FIG. 3 is an example computing system that may implement various systems and methods of the presently disclosed technology.

### DETAILED DESCRIPTION

Systems and methods in accordance with this disclosure are directed to automatically generating a network map by determining connections within a network based on traffic patterns between devices. In certain implementations, the system measures or otherwise collects quantities of data sent and received through interfaces of network devices. The system them analyzes the collected connectivity data to identify pairs of interfaces within the network. Such identification may occur by identifying pairs of interfaces for which the traffic sent and received by each interface of the pair is substantially the same or within a margin. The network map is then modified to include a record of the connection. The updated map including the new connection may then be used to analyze, upgrade, or otherwise evaluate and/or maintain the network.

Certain conventional approaches to network mapping rely on inventory systems that are updated and modified in response to changes to network topology. Such changes may include the addition or removal of network devices and modifications of network paths between devices of the network. Certain inventory systems are highly dependent on manual input of data and, as a result, are prone to having inaccurate, outdated, and incomplete network data. Although some automated approaches to network mapping have been developed, such approaches are also limited. For example, some automated approaches rely on specific messaging protocols that must be supported by the devices of the network in order to provide mapping functionality. To the extent one or more devices of a network do not support a particular protocol, device connections in corresponding portions of the network may remain indeterminate or an operator may be forced to rely on a manual and error prone inventory system. Unsupported mapping protocols are particularly problematic when attempting to integrate and interconnect large pre-existing networks that may have been developed separately using differing protocols. For example, network providers/operators or large companies operating networks having incompatible or differing network protocols may merge or otherwise combine such that the previously disparate networks need to be interconnected.

In light of the foregoing, systems and methods in accordance with the present disclosure determine connections within a network using statistical analysis of traffic sent from and received by interfaces of network devices. By doing so, a network can be automatically mapped without relying on a manual inventory system and may be mapped despite the lack of a particular protocol being shared across network devices. From such maps, changes to network topology through the addition or removal of devices, failure of devices, interconnections between networks, new communications paths between existing devices, failed paths between devices, and other changes may be automatically and efficiently identified.

Network mapping according to the present disclosure involves collecting and analyzing performance data for interfaces of network devices within a network over a time period. Performance data for each interface may include both the quantity of data sent from the interface and the quantity of data received by the interface over the time period. Performance data for different interfaces is then compared to identify pairs of interfaces for which the ratio of the quantity of data sent from a first interface to the quantity of data received by a second interface, and the ratio of the data received by the first interface to the data sent from the second interface are each within a margin. If each ratio is within the margin, the first and second interfaces may be considered connected for purposes of mapping the network. A corresponding entry in a network connection database or similar data source including identifiers and other data corresponding to each of the connected interfaces may then be generated. Additional pairs of interfaces may be identified in a similar manner to generate additional entries in the network connection database and which in turn may be used to map or otherwise generate a topology of the network.

In certain implementations, the performance data is collected by periodically sampling interfaces of the network devices over the time period. For example, each interface may be sampled every five minutes over the course of a day, resulting in 288 performance data samples for each interface. The performance data samples for each interface may then be summed to generate a total quantity of data sent and received by each interface for the time period. In a graphical depiction of the map, new devices may be highlighted, devices removed may be highlighted, new connections may be highlighted, and the like.

To evaluate the ratios of performance data between two interfaces, a difference margin, in the form of a margin of error in one particular embodiment, is used to account for potential variability caused by, among other things, network latency and limitations arising from the method of sampling the interfaces. For example, the quantity of data sent from a first interface between 12:00 PM to 12:05 PM may not equal the quantity of data received by a second interface connected to the first interface during the same time period. Such differences may be attributable, for example, to the first interface transmitting data before 12:05 PM that is subsequently received by the second interface after 12:05 PM due to network latency. Alternatively, network latency may cause the second interface to receive data after 12:00 PM that was sent by the first interface before 12:00 PM. Additional variability may also be caused by sampling of the interfaces. More specifically, the system configured to retrieve performance data from each of the interfaces may only be able to do so from one or a subset of interfaces at a time. Accordingly, the precise timing of when each interface is sampled and the corresponding performance data counts may vary. The variability in the network and performance data sampling system may be accounted for using a margin of error such that two interfaces may be considered connected if the corresponding ratios of data sent and received between the two interfaces are within unity plus or minus the margin of error.

The foregoing examples of variability primarily affect the first and last samples taken during the time period. As a result, the effects of such variability on the performance data ratios may be decreased by increasing the time period over which samples are taken and, as a result, the number of performance data samples collected. In other words, the longer the time period, the greater the proportion of data sent by each interface will be received by the other interface within the time period.

The margin of error may be based on various parameters. In one example implementation, the margin of error may be based on the number of performance data samples collected during the time period. Referring to the previous example in which samples were collected every five minutes for a 24-hour period resulting in 288 samples, for example, the margin of error may be 1/288 or 0.35%. In other implementations, the margin of error may be inversely proportional to the length of the time period such that the longer the time period, the tighter the margin of error required for two interfaces to be considered connected.

In certain implementations, the margin of error may also be modified based on other factors including network downtime, network device downtime, or samples missing from the performance data. For example, the margin of error for a given pair of interfaces may be increased proportionally to an amount of network or device downtime during the time period. Similarly, the margin of error may be increased proportionally to a number of missed samples that may have resulted from, among other things, errors in retrieving and/or storing performance data from one of the interfaces.

Notably, the margin of error used to identify potential connections between interfaces and/or the specific performance data ratios calculated between interfaces provide measures of confidence regarding the likelihood that two interfaces are, in fact, connected. Accordingly, the margin of error and/or performance data ratios for interfaces considered to be connected may be stored within the corresponding entry of the network connection database.

Systems and methods according to the present disclosure are primarily directed to determining connections between interfaces on the data link layer (Layer 2) or network layer (Layer 3) of the standard Open Systems Interconnection (OSI) model. Accordingly, to the extent two interfaces are referred to in this disclosure as being “connected”, such connection includes a physical path between the interfaces but does not necessarily require that the two interfaces be directly connection on the physical (Layer 1) layer. Rather, for purposes of this disclosure, two interfaces are considered connected if data transfer occurs transparently with respect to the data link and network layers. Accordingly, two interfaces may be connected for purposes of this disclosure even if one or more physical layer devices (such as a multiplexer) of the network of interest exist between the interfaces.

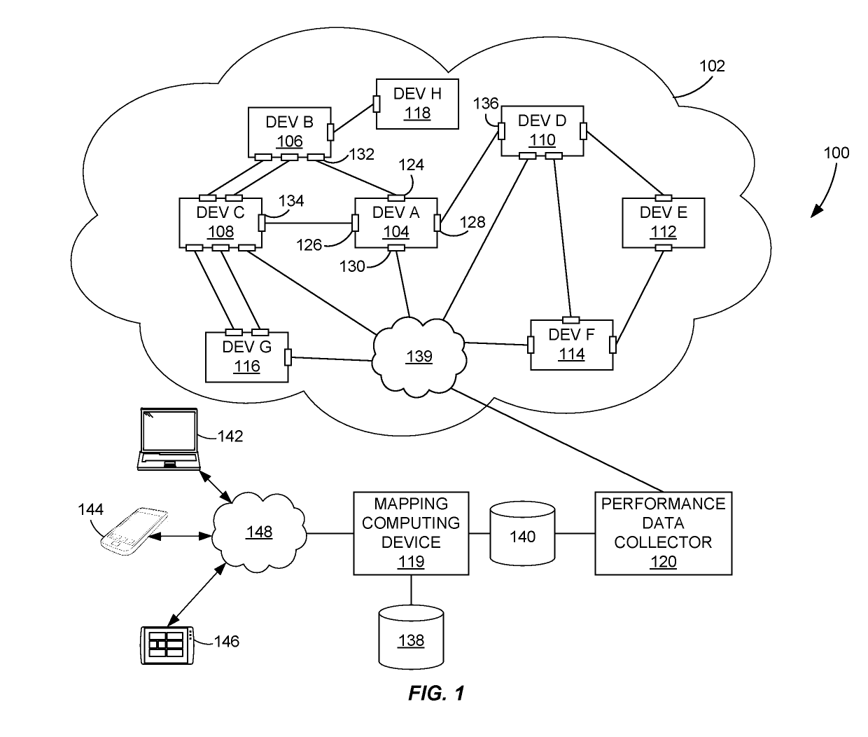

FIG. 1 is a schematic illustration of an example network environment 100. The network environment 100 includes a primary network 102 including a plurality of network devices 104-118. The network environment 100 further includes a mapping computing device 119 and a performance data collector 120.

As shown in FIG. 1, each of the network devices 104-118 (labelled as “DEV A” 104 through “DEV H” 118 in FIG. 1) may be connected to one or more of the other network devices through one or more interfaces. For example, DEV A 104 includes four interfaces 124-130, with the interface 124 connected to an interface 132 of DEV B 106, the interface 126 connected to an interface 134 of DEV C, and the interface 128 connected to an interface 136 of DEV D 110. The fourth interface 130 may be connected to any other interface of a subnetwork 139 of the primary network 102.

Each interface generally includes two channels: a first channel, referred to herein as a TX channel, adapted to transmit data from the interface, and a second channel, referred to herein as an RX channel, adapted to receive data transmitted to the interface. Accordingly, bi-directional communication between two interfaces generally includes connecting the TX channel of the first interface and the RX channel of the second interface and connecting the RX channel of the first interface and the TX channel of the second interface.

The primary network 102 is illustrated in FIG. 1 as having a defined topology. Information regarding the topology or, more specifically, connections between interfaces of the network devices 104-118 may be stored in a database and accessible for viewing the topology of the network 102 and managing the network 102 based on the topology. In the example network environment 100, for example, such information is stored in a network connection database 138. The network connection database 138 is communicatively coupled to the mapping computing device 119, which is configured to retrieve, analyze, and present data stored in the network connection database 138. The mapping computing device 119 is further communicatively coupled to a performance data source 140, which stores performance data collected by the performance data collector 120. In certain implementations, the mapping computing device 119 may be accessible by one or more user computing devices 142-146, such as over an enterprise network 148 of an operator of the primary network 102, such that the user computing devices 142-146 may access the network connection information for various purposes including, without limitation, provisioning new network services over the primary network 102, performing maintenance or modifications to the primary network 102, and analyzing performance of the primary network 102. Although depicted as various distinct devices, various functions may be combined or otherwise implemented on various combinations of devices.

As previously mentioned, the mapping computing device 119 is further configured to generate entries of the network connection database 138 from performance data collected from each of the network devices 104-118. More specifically, the performance data collector 120 is configured to retrieve performance data from each of the network devices 104-118, the performance data corresponding to quantities of data sent and received by interfaces of the network devices 104-118. Following retrieval, the performance data collector 120 may store the performance data in the performance data source 140 for retrieval and processing by the mapping computing device 119.

In certain implementations, retrieval of the performance data from the network devices 104-118 may include the performance data collector 120 individually transmitting or multicasting a performance data request message or command to the network devices 104-118. Each network device 104-118 may then respond with a corresponding response message including the performance data for one or more of its respective interfaces. Alternatively, each of the network devices 104-118 may be configured to periodically transmit their respective performance data to the performance data collector 120 without first receiving a request message or command from the performance data collector 120.

While illustrated as a separate computing device in the network environment 100 of FIG. 1, the performance data collector 120 may instead be a collective of separate performance data collectors, each performance data collector being tasked with collecting performance data for a subset of network devices of the primary network 102. Some or all of the functionality of the data collector 120 may also be incorporated, in whole or in part, into the mapping computing device 119. In still other implementations, the performance data collector 120 may instead be implemented through software or firmware deployable onto each of the network devices 104-118. For example, such software may cause each of the network devices on which it is deployed to periodically transmit performance data to the performance data source 140.

In implementations in which the performance data collector 120 transmits requests to network devices for their respective performance data, the performance data collector 120 may be provided with an inventory or similar list of network devices and their respective IP addresses. The performance data collector 120 may then transmit requests for performance data to each network device included in the list. To the extent network devices are added or removed from the network 102, the inventory provided to the performance data collector 120 may be updated accordingly.

In implementations in which the performance data collector 120 receives performance data from the network devices without first submitting a request, the performance data collector 120 may generate a list of network devices from the received performance data. For example, in one implementation, the performance data collector 120 may identify network devices within the network 102 based on source IP addresses included in the performance data packets received by the performance data collector 120. Notably, in such an implementation, the performance data collector 120 may dynamically update a list of network devices within the network 102 as devices are added or removed based on whether performance data is received from the new or removed network devices.

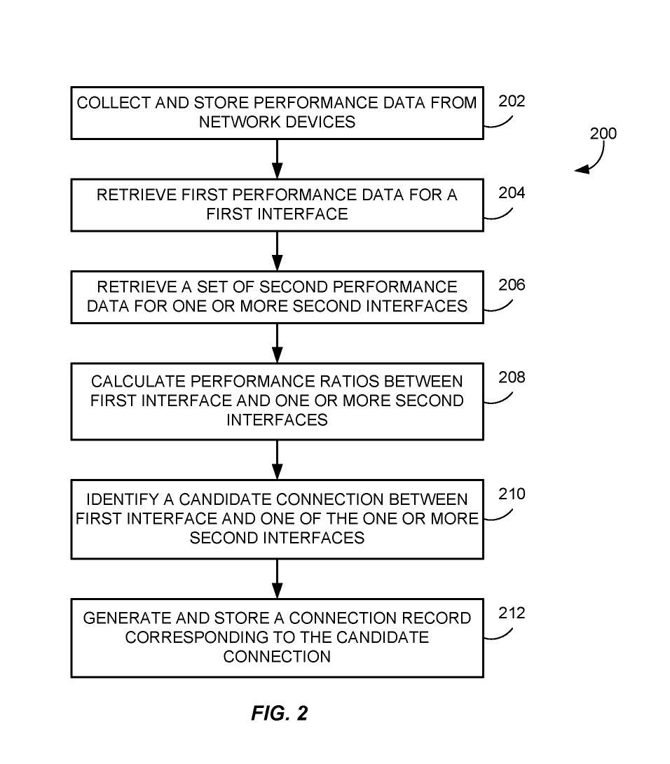

Operation of the mapping computing device 119 and the performance data collector 120 are now discussed with reference to FIG. 2, which is a flow chart illustrating a method 200 of identifying a network connection between interfaces of network devices.

At operation 202, performance data is collected from each interface of the primary network 102 by the performance data collector 120. For each interface, the performance data includes each of a quantity of data sent from the interface and a quantity of data received by the interface. The quantity of data may be measured in any unit including, without limitation, bits, bytes, and packets.

In general, the performance data collector 120 can be any implementation of hardware, software, or both hardware and software adapted to collect and store network traffic data. Such collection and storage may occur in various ways. In one specific example, the performance data is collected by periodically transmitting a request for the performance data from the performance data collector 120 to each network device of the primary network 102 according to an inventory or similar list of network devices accessible by the performance data collector 120. In response to the message, each network device may transmit a response message to the performance data collector 120 including the performance data for each interface of the network device and a time stamp. The performance data collector 120 may store the received performance data and periodically send additional request messages for updated performance data for each network device. In another specific example, each network device may automatically transmit timestamped performance data to the performance data collector 120, which then aggregates and stores the received performance data. Such transmission may occur periodically (e.g., every five minutes) or may occur in response to completion of a particular flow of data through the network device. In yet another specific example, the performance data collector 120 may be or otherwise interact with other traffic monitoring systems. For example, the performance data collector 120 may be or communicate with a tool for collecting, monitoring, and/or analyzing network traffic, such as a NetFlow implementation.

In certain implementations, the performance data collector 120 collects performance data for each interface of the primary network 102 and stores the collected performance data in the performance data source 140. The performance data collector 120 may be configured to collect the performance data after a time period or may collect multiple samples of data during the course of the time period, each sample including performance data for the time period since the preceding sample. The exact timing of sampling by the performance data collector 120 may vary provided sampling is performed in a manner that ensures each time interval for each interface is accounted for in the collected data. Accordingly, the sampling period may depend on, among other things, the number of interfaces for which performance data is collected, and the general speed and performance of the data collector 120.

Performance data collected by the performance data collector 120 may be stored in a performance data source 140. In certain implementations, each sample collected by the performance data collector 120 is stored as a separate entry in the performance data source 140 with each entry including, without limitation, one or more of an identifier for the interface corresponding to the performance data, a time stamp indicating the sampling time, the quantity of data sent from the interface during the relevant time period, and the quantity of data received by the interface during the relevant time period. Accordingly, the performance data source 140 serves as a collection of performance data from which performance data for particular network devices and interfaces may be retrieved for analysis.

At operation 204, first performance data is retrieved for a first interface of a first network device from the performance data source 140 by the mapping computing device 119. For purposes of the following discussion, it is assumed that the specific connection for the interface 124 of the network device 104 is to be determined and, as a result, the network device 104 is considered the first network device and the interface 124 is considered the first interface.

The first performance data is generally the performance data for the first interface 124 over a time period. For example, retrieving the first performance data may include retrieving each sample of performance data corresponding to the interface 124 that is stored within the performance data source 140 and that was previously obtained by the performance data collector 120 from the interface 124 over a 24-hour period. The first performance data may be summed or otherwise combined to calculate each of a total quantity of data sent from the interface 124 and a total quantity of data received by the interface 124.

At operation 206, a second set of performance data is similarly retrieved for interfaces of other network devices in the primary network 102. In certain implementations, the second set of performance data may include quantities of data sent and received by each interface of each network device in the primary network 102. Alternatively, and to improve performance of the system, the second interfaces and second network devices represented in the second set of performance data may correspond to a subset of interfaces and/or network devices of the primary network 102. For example, the network devices included in the retrieved second performance data may be limited by, without limitation, one or more of a network market, a geographic location, a network device type, a network type, or any similar characteristics of the network devices.

The second set of performance data generally includes performance data for the interfaces of the other network devices over the same time period as the first performance data. So, referring to the previous example, the second set of performance data may include the quantity of data sent from and received by each interface of the other network devices 106-118 for the same 24-hour period as the performance data obtained for the interface 124.

At operation 208, performance data ratios are calculated for the first interface and each interface of the second set of performance data. The performance data ratios are pair of ratios between data sent and received between the interface 124 and each interface included in the second set of performance data. More specifically, for each interface pair including the interface 124 and a second interface included in the second set of performance data, the performance data ratios are calculated as the quantity of data sent from the interface 124 to the quantity of data received by the second interface and the quantity of data received by the interface 124 to the quantity of data sent by the second interface.

At operation 210 and after calculation of the performance data ratios, a candidate connection is identified. The term “candidate connection” is used herein to refer to a statistically likely connection between two interfaces of the primary network 102.

Generally, identifying the candidate connection includes identifying the interface pair with performance data ratios closest to unity. In other words, the candidate connection is identified as the interface pair for which the quantity of data sent from the interface 124 most closely matches the quantity of data received by the second interface and the quantity of data received by the interface 124 most closely matches the quantity of data sent by the second interface. Identifying the candidate connection may include ranking or otherwise comparing the performance data ratios for multiple interface pairs. Such a comparison may include, among other things, ranking the interface pairs based on one of an absolute and a relative deviation between their respective performance data ratios and unity.

Identification of the candidate connection may also include comparison of the performance data ratios to a margin of error. The margin of error generally corresponds to a level of confidence that the identified candidate connection is, in fact, an actual connection between the interfaces of the interface pairs. In other words, an interface pair may only be considered a candidate connection if its performance ratios are closest to unity as compared to other interface pairs and each of its performance data ratios are within unity plus or minus the margin of error.

The margin of error may be based on various parameters. In one example implementation, the margin of error may be based on the number of performance data samples collected during the time period. For example, if the performance data for each of the interface 124 and the interfaces of the second set of performance data were obtained as samples collected every five minutes over a 24-hour period (for a total of 288 samples), the margin of error may correspond to one sampling period ( 1/288 or 0.35%). In other implementations, the margin of error may be inversely proportional to the length of the time period such that the longer the time period, the tighter the margin of error required for the interface 124 and a second interface to be considered connected.

In certain implementations, the margin of error may also be modified based on other factors including network downtime, network device downtime, or samples missing from the performance data. For example, the margin of error for a given pair of interfaces may be increased proportionally to an amount of network or device downtime during the time period. Similarly, the margin of error may be increased proportionally to a number of missed samples that may have resulted from, among other things, errors in retrieving and/or storing performance data from one of the interfaces.

Although the foregoing example method 200 included identifying a single candidate connection, in certain implementations, more than one interface pair may be identified as a potential candidate connection and a secondary analysis may be conducted to identify which of the interface pairs is most likely indicative of a connection. In some implementations, this secondary analysis may include applying a tighter margin of error to the previously generated performance data ratios. In other implementations, additional performance data corresponding to the interface pairs may be retrieved from the performance data source 140 and the performance data ratios for the interface pairs may be recalculated and reevaluated.

Secondary analysis may also include what is referred to herein as sample “shaving.” In certain implementations, deviations between the calculated performance data ratios and unity may be caused, at least in part, by technical limitations of the mapping system and inherent delays (e.g., network latency) associated with the primary network 102. At least some of these deviations manifest themselves as particularly significant differences in samples obtained at the beginning and end of a particular time periods. As a result, in certain implementations, secondary analysis may include recalculating the performance data ratios while excluding one or more of the first samples and/or one or more of the last samples of performance data. The concept of sample shaving may also be applied during the initial analysis of the performance data.

The foregoing examples of secondary analysis may also be applied in instances when no candidate connections are identified during operation 210 such that the interface pairs closest to meeting the candidate connection criteria may be reevaluated using one or more of the previously described techniques until a candidate connection is identified.

At operation 212, assuming a candidate connection has been identified in operation 210, a record is generated by the mapping computing device 119 in the network connection database 138, the record corresponding to the identified candidate connection. In certain implementations, the record includes an identifier corresponding to each of the interfaces. The record may also include additional information including, without limitation, one or more of the performance data ratios or underlying performance data for the candidate connections, the margin of error met by the candidate connection, and a time stamp indicating when identification of the candidate connection occurred.

The foregoing process of identifying a connection for a given interface of the primary network 102 may be executed for each interface of the primary network 120 to populate the network connection database 138. Such data may then be used for, among other things, generating network topologies, generating connection lists for specific network devices, and confirming statuses of specific network devices or interfaces. Notably, steps of the foregoing process need not be executed sequentially for each interface in the network. For example, performance data ratios for each pair of interfaces in the primary network 102 (or a filtered subset thereof) may be calculated in bulk followed by subsequent analysis of the calculated ratios to identify connected pairs of interfaces.

In certain implementations, for example, the user computing devices 142-146 may communicate with the mapping computing device 119 to access data of the network connection database 138 using one or more application programming interfaces (APIs). Such APIs may include libraries of functions and subroutines executable by the user computing devices 142-146 to retrieve or otherwise perform operations on data corresponding to connections in the primary network 102. In one example function, an identifier corresponding to a network device may be provided and a list of all interfaces and their respective connections may be returned. In another example function, a specific interface or a combination of a specific device and interface of the device may be provided and a connected interface may be provided. In still another example, a pair of devices and/or interfaces may be provided and an indication of whether the devices or interfaces are connected may be returned. For example, if two interfaces or an interface and a network device are provided, the function may return a Boolean true/false value. If two network devices are provided, a Boolean true/false value may be returned and/or a listing of the connected interfaces between the two network devices may be returned.

To provide further context for embodiments of the present disclosure, Tables 1-4, below, include example data that may be analyzed by a computing device, such as the mapping computing device 119 of FIG. 1, to determine interconnections within a network. For purposes of the following example, data is collected from two network devices, device A (devA) and device B (devB). devA further includes three interfaces, which are referred to as devAintA, devAintB, and devAintC. Similarly, devB further includes three interfaces, which are referred to as devBintA, devBintB, and devBintC. Each interface may also be assigned a name, as listed in Tables 1 and 2.

Tables 1 and 2 include traffic data for each of devA and devB, respectively. More specifically, for each interface of devA, a quantity of data transferred (TX) and received (RX) over a particular time period is calculated or otherwise obtained. Similar data is also collected for each interface of devB.

TABLE 1
Traffic data for interfaces of Device A (devA)

| ID | Interface Name | TX | RX |
|---|---|---|---|
| devAintA | port-channel 101 | 23291610344 | 16592482040 |
| devAintB | tengigabitethernet 0/26 | 10859744096 | 7047151304 |
| devAintC | tengigabitethernet 0/25 | 12431867304 | 9545332016 |

TABLE 2
Traffic data for interfaces of Device B (devB)

| ID | Interface Name | TX | RX |
|---|---|---|---|
| devBintA | ae3 | 15656482840 | 23351412432 |
| devBintB | Xe-9/0/0 | 8994572248 | 11874972352 |
| devBintC | Xe-9/0/1 | 661867856 | 10476437320 |

After collection of traffic data for each interface, various ratios may be calculated based on the traffic data. For example, Table 3 includes ratios of data transmitted from each interface of devA to each interface of devB. Similarly, Table 4 includes ratios of data received by the interfaces of devA to data transmitted by the interfaces of devB.

TABLE 3
Ratios of data transferred from interfaces of devA to interfaces of devB

| | | RX | | |
|---|---|---|---|---|
| TX/RX | | devBintA | devBintB | devBintC |
| TX | devAintA | 0.997439038 | 1.961403332 | 2.223237694 |
| | devAintB | 0.465057269 | 0.914506895 | 1.036587512 |
| | devAintC | 0.532381814 | 1.046896526 | 1.186650282 |

TABLE 4
Ratios of data received by interfaces of devA from interfaces of devB

| | | TX | | |
|---|---|---|---|---|
| RX/TX | | devBintA | devBintB | devBintC |
| RX | devAintA | 1.059783491 | 1.844721637 | 2.490665141 |
| | devAintB | 0.450110755 | 0.783489321 | 1.057834147 |
| | devAintC | 0.609672818 | 1.061232458 | 1.432831185 |

The ratios in Tables 3 and 4 may then be analyzed to determine likely pairings of interfaces of devA and interfaces of devB. In the current example, one method of doing so may involve using the data in Table 3 to first identify candidate pairings of interfaces based on the traffic transmitted from devA to devB. Using the ratio approach of the current example, the candidate pairings are those with ratios closes to unity. In other words, the candidate pairings of Table 3 are those for which the quantity of data sent by an interface of devA most closely matches the quantity of data received by an interface of devB. Based on this approach, the strongest candidate pairing is devAintA and devBintA for which the quantity of data transmitted by devAintA and the quantity of data received by devBintA differ by only 0.3%. The next most likely pairing based on the results of Table 3 is between devAintB and devBintC for which the same difference is approximately 3.7%. Finally, the next most likely pairing is between devAintC and devBintB for which the difference is approximately 4.7%. In contrast to the three most likely interface pairings indicated in Table 3, many of the other calculated ratios indicate significant differences between the amount of traffic transmitted and received by pairs of interfaces. For example, the amount of data transmitted from devAintA was only approximately half of that received by devBintB and devBintC, strongly suggesting that devAintA is not paired with either devBintB or devBintC.

The data in Table 4 may then be used to further verify that the candidate pairings are likely actual pairings. For example, for each candidate pairing identified from Table 3, the entry of Table 4 corresponding to traffic in the opposite direction may be examined to determine if the ratio of Table 4 is similarly near unity. So, for the candidate pairing of devAintA and devBintA, the corresponding entry of Table 4 for devAintA and devBintA is identified and analyzed. As indicated in Table 4, this inverse ratio indicates a deviation of approximately 6.0% between the quantity of data received at devAintA and the quantity of data transmitted from devBintA. Although not as close as the 0.3% observed for the inverse performance data, such deviation confirms, with relatively strong likelihood that devAintA and devBintA are likely connected. The likelihood of such a connection is further bolstered by the even greater deviation between the data received at devAintA and that transmitted by devBintB (approximately 55%) and devBintC (approximately 40%).

The example data of Tables 1-4 is provided merely to illustrate one implementation of the present disclosure. In other implementations, the data may include two or more devices with each of the devices including any number of interfaces. The same general process applies regardless of the number of interfaces involved. Specifically, quantities of data sent and received for a first interface are compared to quantities of data received and sent, respectively, for a second interface. This comparison may be repeated for all possible interface pairings within the network. So, for example, if the network further included device C, the foregoing ratios between data transmitted and received would also be calculated between the interfaces of device A and device C and device B and device C. Each of the calculated ratios would then be evaluated to identify candidate pairings, as previously discussed.

The complexity and scope of the analysis for identifying candidate pairings within a network may grow exponentially as network devices and interfaces are added. As a result, as a network increases in size, the computational resources (e.g., memory, processing power) and time required to evaluate each possible connection between devices within the network may be prohibitive. As a result, various methods for limiting the number of evaluated devices and interfaces may be implemented to conserve resources and to improve the overall efficiency of the analysis performed. For example, in one implementation, network attachment rules that reduce the candidate set of which devices are allowed to be connected may be employed to reduce the scope of the analysis. Similarly, the analysis may be limited to one or more subnetworks within a broader network.

In the example illustrated by Tables 1-4 pairings were identified for each interface of devA and devB. In certain instances, however, the traffic data may be inconclusive in that a given interface may have no potential pairings or more than one potential pairing. For example, if the example data of Tables 1-4 was subject to a further requirement that the ratios in each direction be within three percent of unity, no identified candidate pairings would result. In instances when no pairings are identified, a supplemental analysis may be conducted. For example, in certain implementations, the time period for which traffic data is collected may be broadened to include additional samples of traffic data. By doing so, the total number of data units transmitted and received is increased, thereby minimizing the effects of the various errors previously described in this disclosure.

The example illustrated by Tables 1-4 also relies on the ratios of data sent and received by interfaces of devA to data received and sent by interfaces of devB. Such ratios are only an example of calculations that may be used to identify potential interface pairings. In other implementations, for example, the reverse relationship for either ratio may be used. In still other implementations, other calculations may be used including, without limitation, differences between data units sent or received by interfaces, average quantities of data sent or received by interfaces over time periods, and other statistical values calculated based on traffic between interfaces.

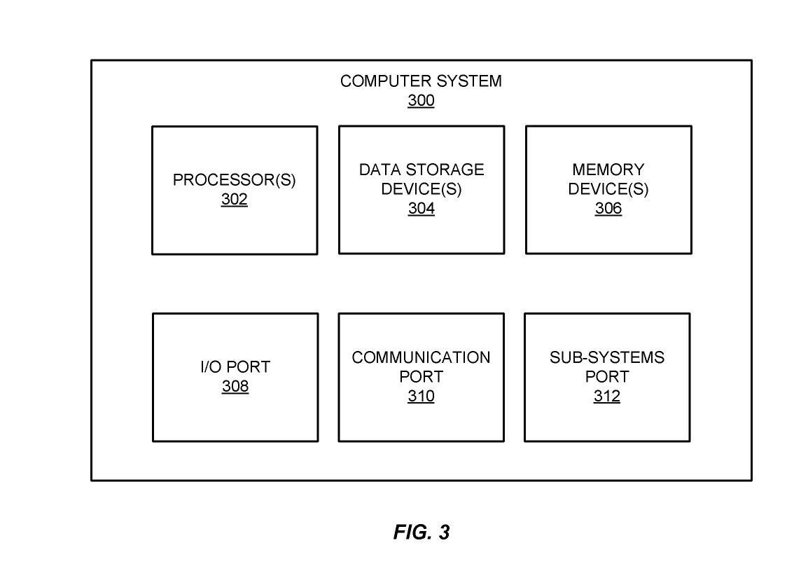

Referring to FIG. 3, a schematic illustration of an example computing system 300 having one or more computing units that may implement various systems and methods discussed herein is provided. It will be appreciated that specific implementations of these devices may be of differing possible specific computing architectures not all of which are specifically discussed herein but will be understood by those of ordinary skill in the art.

The computer system 300 may be a computing system capable of executing a computer program product to execute a computer process. Data and program files may be input to computer system 300, which reads the files and executes the programs therein. Some of the elements of the computer system 300 are shown in FIG. 3, including one or more hardware processors 302, one or more data storage devices 304, one or more memory devices 308, and/or one or more ports 308-312. Additionally, other elements that will be recognized by those skilled in the art may be included in the computing system 300 but are not explicitly depicted in FIG. 3 or discussed further herein. Various elements of the computer system 300 may communicate with one another by way of one or more communication buses, point-to-point communication paths, or other communication means not explicitly depicted in FIG. 3.

The processor 302 may include, for example, a central processing unit (CPU), a microprocessor, a microcontroller, a digital signal processor (DSP), and/or one or more internal levels of cache. There may be one or more processors 302, such that the processor 302 comprises a single central-processing unit, or a plurality of processing units capable of executing instructions and performing operations in parallel with each other, commonly referred to as a parallel processing environment.

The computer system 300 may be a conventional computer, a distributed computer, or any other type of computer, such as one or more external computers made available via a cloud computing architecture. The presently described technology is optionally implemented in software stored on data storage device(s) 304, stored on memory device(s) 306, and/or communicated via one or more of the ports 308-312, thereby transforming the computer system 300 in FIG. 3 to a special purpose machine for implementing the operations described herein. Examples of the computer system 300 include personal computers, terminals, workstations, mobile phones, tablets, laptops, personal computers, multimedia consoles, gaming consoles, set top boxes, and the like.

One or more data storage devices 304 may include any non-volatile data storage device capable of storing data generated or employed within the computing system 300, such as computer executable instructions for performing a computer process, which may include instructions of both application programs and an operating system (OS) that manages the various components of the computing system 300. Data storage devices 304 may include, without limitation, magnetic disk drives, optical disk drives, solid state drives (SSDs), flash drives, and the like. Data storage devices 304 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. One or more memory devices 306 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 304 and/or the memory devices 306, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computer system 300 includes one or more ports, such as an input/output (I/O) port 308, a communication port 310, and a sub-systems port 312, for communicating with other computing, network, or vehicle devices. It will be appreciated that the ports 308-312 may be combined or separate and that more or fewer ports may be included in the computer system 300.

The I/O port 308 may be connected to an I/O device, or other device, by which information is input to or output from the computing system 300. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing system 300 via the I/O port 308. Similarly, the output devices may convert electrical signals received from the computing system 300 via the I/O port 308 into signals that may be sensed as output by a human, such as sound, light, and/or touch. The input device may be an alphanumeric input device, including alphanumeric and other keys for communicating information and/or command selections to the processor 302 via the I/O port 308. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, a gravitational sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

The environment transducer devices convert one form of energy or signal into another for input into or output from the computing system 300 via the I/O port 308. For example, an electrical signal generated within the computing system 300 may be converted to another type of signal, and/or vice-versa. In one implementation, the environment transducer devices sense characteristics or aspects of an environment local to or remote from the computing device 300, such as, light, sound, temperature, pressure, magnetic field, electric field, chemical properties, physical movement, orientation, acceleration, gravity, and/or the like. Further, the environment transducer devices may generate signals to impose some effect on the environment either local to or remote from the example the computing device 300, such as, physical movement of some object (e.g., a mechanical actuator), heating or cooling of a substance, adding a chemical substance, and/or the like.

In one implementation, a communication port 310 is connected to a network by way of which the computer system 300 may receive network data useful in executing the methods and systems set out herein as well as transmitting information and network configuration changes determined thereby. Stated differently, the communication port 310 connects the computer system 300 to one or more communication interface devices configured to transmit and/or receive information between the computing system 300 and other devices by way of one or more wired or wireless communication networks or connections. Examples of such networks or connections include, without limitation, Universal Serial Bus (USB), Ethernet, Bluetooth®, Near Field Communication (NFC), Long-Term Evolution (LTE), and so on. One or more such communication interface devices may be utilized via communication port 310 to communicate one or more other machines, either directly over a point-to-point communication path, over a wide area network (WAN) (e.g., the Internet), over a local area network (LAN), over a cellular (e.g., third generation (3G) or fourth generation (4G)) network, or over another communication means. Further, the communication port 310 may communicate with an antenna for electromagnetic signal transmission and/or reception.

The system set forth in FIG. 3 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium, optical storage medium; magneto-optical storage medium, read only memory (ROM); random access memory (RAM); erasable programmable memory (e.g., EPROM and EEPROM); flash memory; or other types of medium suitable for storing electronic instructions.

While the present disclosure has been described with reference to various implementations, it will be understood that these implementations are illustrative and that the scope of the present disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended thereto.

We claim:

1. A method of mapping network connections comprising:
obtaining, using a computing device communicatively coupled to a network, traffic data including quantities of data sent and received for each interface of a plurality of interfaces within the computer network;
identifying, using the computing device, a potential connection between a pair of interfaces of the plurality of interfaces, wherein identifying the potential connection includes determining that quantities of data sent and received for a first interface of the pair of interfaces for a time period correspond to quantities of data received and sent, respectively, for a second interface of the pair of interfaces for the time period; and
generating and storing, using the computing device, network topology data including a record corresponding to the potential connection, the record including an identifier for each of the first interface and the second interface.

2. The method of claim 1, wherein obtaining the traffic data comprises:
generating, for each network device including at least one of the plurality of interfaces, a request message, the request message configured to cause the network device to generate and transmit to the computing device at least one response message including quantities of data sent and received for each interface of the network device for the time period; and
transmitting each request message to its respective network device.

3. The method of claim 1, wherein identifying the potential connection includes determining that variation between the quantity of data sent from the first interface and the quantity of data received at the second interface and variation between the quantity of data received at the first interface and the quantity of data sent from the second interface are each within a respective margin of error.

4. The method of claim 3, wherein each of the respective margins of error are based, at least in part, on at least one of a length of the time period and a period of network downtime identified by the computing device.

5. The method of claim 1, wherein the quantities of data included in the traffic data are measured in at least one of bits, bytes, or packets.

6. A system for mapping network connections, the system comprising:
a computing device configured to:
obtain traffic data for a network including a plurality of interfaces, the traffic data corresponding to quantities of data sent and received from each of the plurality of interfaces;
identify potential connections between one or more pairs of the plurality of interfaces, wherein identifying each potential connection includes determining that quantities of data sent and received for a first interface of the pair of interfaces for a time period correspond to quantities of data received and sent, respectively, for a second interface of the pair of interfaces for the time period; and
automatically update a database of network topology data, wherein automatically updating the database includes adding or modifying a record of the database for each potential connection, each record including an identifier for each of the first interface and the second interface of the potential connection.

7. The system of claim 6 further comprising a traffic data collection module in communication with the computing device, the traffic data collection module configured to collect traffic data for at least one interface of the plurality of interfaces and to provide the collected traffic data to the computing device.

8. The system of claim 7, wherein the traffic data collection module is configured to transmit request messages to one or more network devices of the network, each of the one or more network devices including at least one interface of the plurality of interfaces, each request message configured to cause the network device receiving the request message to generate and transmit a response message including traffic data for each interface of the network device.

9. The system of claim 7, wherein the traffic data collection module is executed by a network device including at least one of the plurality of interfaces.

10. The system of claim 6, wherein the computing device is configured to predict connections between pairs of interfaces by determining that variation between the quantity of data sent from the first interface and the quantity of data received at the second interface and variation between the quantity of data received at the first interface and the quantity of data sent from the second interface are each within a respective margin of error.

11. The system of claim 10, wherein the margin of error is based, at least in part, on at least one of a length of the time period and a period of network downtime.

12. The system of claim 6, wherein the quantities of data of the traffic data measured in at least one of bits, bytes, and packets.

13. The system of claim 6 further comprising a data source communicatively coupled to the computing device, wherein the data source is configured to receive and store traffic data for each of the plurality of interfaces for subsequent retrieval and analysis by the computing device.

14. A method of identifying connections between devices of a network, the method comprising:
obtaining, at a computing device, first performance data for a first interface of the network, the first performance data including each of a quantity of data sent through the first interface during a time period and a quantity of data received through the first interface during the time period;
obtaining, at the computing device, second performance data for a second interface of the network, the second performance data including each of a quantity of data sent through the second interface during the time period and a quantity of data received through the second interface during the time period;
identifying, using the computing device, a connection between the first interface and the second interface by determining each of a first ratio and a second ratio are within a margin of error, the first ratio being the quantity of data sent through the first interface to the quantity of data received by the second interface and the second ratio being the quantity of data sent from the second interface to the quantity of data received by the first interface.
in response to identifying the connection, automatically updating a database record corresponding to the connection using the computing device.

15. The method of claim 14, further comprising:
transmitting, using the computing device, a first request to a first network device including the first interface, the first request configured to cause the first network device to generate and transmit a first response message including the first performance data for storage of the first performance data in a data source; and
transmitting, using the computing device, a second request to a second network device including the second interface, the second request configured to cause the second network device to generate and transmit a second response message including the second performance data for storage of the second performance data in the data source.

16. The method of claim 15 wherein the first request is one of a plurality of first requests transmitted periodically to the first network device and the second request is one of a plurality of second requests transmitted periodically to the second network device.

17. The method of claim 14 further comprising generating, using the computing device, a connection record in a data source, the connection record including a first identifier corresponding to the first interface and a second identifier corresponding to the second interface.

18. The method of claim 14, wherein the first performance data is a sum of first performance data samples collected from the first interface over the time period and the second performance data is a sum of second performance data samples collected from the second interface over the over the time period.

19. The method of claim 18, wherein the margin of error is based, at least in part, on the quantity of first performance data samples and the quantity of second performance data samples.

20. The method of claim 18, wherein the first performance data samples are a subset of data samples collected from the first interface over the time period and the second performance data samples are a subset of data samples collected from the second interface over the time period.
